(19) United States
(12) Patent Application Publication
(10) Pub. No.: US 2012/0185794 A1
(43) Pub. Date: Jul. 19, 2012

(54) Method and Apparatus for Managing Buttons on Taskbar

(75) Inventors: Bo Qin, Beijing (CN); Xiangyang Li, Beijing (CN); Chi Zhang, Beijing (CN)

(73) Assignees: BEIJING LENOVO SOFTWARE LTD., Beijing (CN); LENOVO (BEIJING) CO., LTD., Beijing (CN)

(21) Appl. No.: 13/394,926

(22) PCT Filed: Sep. 6, 2010
(86) PCT No.: PCT/CN2010/076639

§ 371 Date: Apr. 5, 2012

(30) Foreign Application Priority Data
Sep. 10, 2009 (CN) 200910092892.1

(51) Int. Cl. G06F 3/048

(52) U.S. Cl. 715/779

(57) ABSTRACT

A method and an apparatus for managing buttons on a taskbar are disclosed. The method is applied to the system with a first window and a second window, wherein, the first window is corresponding to a first button on the taskbar and has a first application program identifier, and the second window is corresponding to a second button on the taskbar and has a second application program identifier. The method comprises: a management command is received (S110); the second application program identifier and the first application program identifier are set to be equal according to the management command (S120); and the first button and the second button with the equal application program identifiers are combined on the taskbar forming a third button (S130). The method and the apparatus for managing buttons on the taskbar can define the group of buttons on the taskbar according to the demands of users flexibly.

### BACKGROUND

The invention relates to task bar buttons, and in particular, to a method and apparatus for managing task bar buttons.

In an operating system, a window of an opened application program on a desktop is mapped as a button in a task bar. We can select the currently selected window through the button in the task bar, and then perform operations. Taking the Windows operating system as an example, starting from Windows XP period, these task bar buttons have had a new organization manner in which similar task bar buttons are grouped into a group, that is, the Windows itself will group the similar task bar buttons into a group (for example, a plurality of IE (Internet Explorer) windows are grouped into a group, and a plurality of Windows explorer windows are grouped into a group). The advantage of this is that the number of the buttons displayed on the task bar can be reduced, thereby reducing the possibility that the task bar needs to be paged after a plurality of windows are opened, facilitating the user to manage similar tasks, and simplifying the user's operations.

During the process for implementing the embodiment of the invention, the inventor found that, there are at least following defects in the prior art: such existing simplex grouping manner can not satisfy the user's demand. For example, it is assumed that there are windows of 10 different application programs opened on the current Windows desktop. According to the grouping strategy of the Windows itself, these 10 windows will be arranged on the task bar as individual buttons, and not be grouped, so that the task bar with limited length needs to be paged since the 10 buttons can not be arranged. At this time, if the user needs to find a window on a relatively tail position, it is difficult for the user to locate the window at once, Thus, in the case that a plurality of windows are opened on the desktop, the user hopes to be able to flexibly group these windows.

### SUMMARY

Embodiments of the present invention propose a method and apparatus for managing task bar buttons which can flexibly define the group(s) of the task bar buttons according to the demand of a user, thereby satisfying personality demand of the user and bringing better user experience.

The technical solutions of the embodiments of the invention are implemented as follows:

A method for managing task bar buttons, applicable to a system having a first window and a second window, said first window corresponding to a first button of a task bar and having a first application program identifier, said second window corresponding to a second button of the task bar and having a second application program identifier, the method comprising:

receiving a managing command;

according to said managing command, setting said second application program identifier and said first application program identifier to be equal to each other; and

combining said first button and said second button with an equal application program identifier on said task bar, to form a third button.

Preferably, said according to said managing command, setting said second application program identifier and said first application program identifier to be equal includes:

obtaining a first window handle of said first window and a second window handle of said second window;

obtaining a first process corresponding to said first window handle and a second process corresponding to said second window handle; and

according to said managing command, injecting a code segment or a Dynamic Link Library (DLL) which sets application program identifiers into said first process and said second process, obtaining the first application program identifier of said first window and the second application program identifier of said second window, and setting said second application program identifier and said first application program identifier to be equal to each other.

Preferably, said setting said second application program identifier and said first application program identifier to be equal comprises:

setting said second application program identifier and said first application program identifier to be an equal third value.

Preferably, before said receiving a managing command, the method further comprises:

obtaining a moving operation on said first button or said second button of said task bar from a user; and

when said moving operation makes said first button at least partially overlap with said second button, generating said managing command.

A method for managing task bar buttons, applicable to a system having a first window, said first window corresponding to a first button of a task bar and having a first application program identifier, the method comprising:

when a second window is opened, detecting whether said second window and said first window satisfy a grouping strategy, and if so, issuing a managing command, said second window corresponding to a second button of a task bar and having a second application program identifier;

according to said managing command, setting said second application program identifier and said first application program identifier to be equal to each other; and

combining said first button and said second button with an equal application program identifier on said task bar, to form a third button.

Preferably, before said detecting whether said second window and said first window satisfy a grouping strategy the method further comprises:

according to application program name, application program attribute, or application process attribute, generating said grouping strategy.

Preferably, the method further includes after said combining said first button and said second button with an equal application program identifier on said task bar, to form a third button:

obtaining first window information of said first window and second window information of said second window; and

generating said grouping strategy according to said first window information and said second window information.

A apparatus for managing task bar buttons, applicable to a system having a first window and a second window, said first window corresponding to a first button of a task bar and having a first application program identifier, said second window corresponding to a second button of the task bar and having a second application program identifier, the method comprising:

receiving module, configured for receiving a managing command;

setting module, configured for, according to said managing command, setting said second application program identifier and said first application program identifier to be equal to each other; and

combining module, configured for combining said first button and said second button with an equal application program identifier on said task bar, to form a third button.

Preferably, said setting module includes:

first obtaining submodule, configured for obtaining a first window handle of said first window and a second window handle of said second window;

second obtaining submodule, configured for obtaining a first process corresponding to said first window handle and a second process corresponding to said second window handle; and

setting submodule, configured for, according to said managing command, injecting a code segment or a Dynamic Link Library (DLL) which sets application program identifiers into said first process and said second process, obtaining the first application program identifier of said first window and the second application program identifier of said second window, and setting said second application program identifier and said first application program identifier to be equal to each other.

Preferably, the apparatus further includes:

third obtaining module, configured for obtaining a moving operation on said first button or said second button of said task bar from a user; and

first generating module, configured for, when said moving operation makes said first button at least partially overlap with said second button, generating said managing command.

A apparatus for managing task bar buttons, applicable to a system having a first window, said first window corresponding to a first button of a task bar and having a first application program identifier, the method comprising:

detecting module, configured for, when a second window is opened, detecting whether said second window and said first window satisfy a grouping strategy, and if so, issuing a managing command, said second window corresponding to a second button of a task bar and having a second application program identifier;

setting module, configured for, according to said managing command, setting said second application program identifier and said first application program identifier to be equal to each other; and

combing module, configured for combining said first button and said second button with an equal application program identifier on said task bar, to form a third button.

Preferably, the apparatus further includes:

fourth obtaining module, configured for obtaining first window information of said first window and second window information of said second window; and

second generating module, configured for generating said grouping strategy according to said first window information and said second window information.

The technical solutions of the embodiments of the invention modify the application program identifiers of the windows corresponding to the task bar buttons that is desired to be grouped into the same group to the same value by modifying the application program identifiers of the windows corresponding to the task bar buttons, so that the task bar buttons corresponding to the windows with the same application program identifier can be grouped into a group; the embodiments of the invention provide a new grouping manner for the task bar buttons which can flexibly define the grouping of the task bar buttons according to the demand of a user, thereby satisfying personality demand of the user and bringing better user experience.

### BRIEF DESCRIPTION OF THE DRAWINGS

In order to explain the technical solutions of the embodiments of the invention more clearly, drawings to be used in the description of the embodiments will be simply presented below. Obviously, the drawings in the below description are only some embodiments of the invention, and it is appreciated by the person skilled in the art that other drawings can be obtained according to these drawings without any creative labor.

FIG. 1 is a flowchart of a first embodiment of a method for managing task bar buttons according to the invention;

FIG. 2 is a flowchart of a second embodiment of a method for managing task bar buttons according to the invention;

FIG. 3 is a structural view of a first embodiment of a apparatus for managing task bar buttons according to the invention; and

FIG. 4 is a structural view of a second embodiment of a apparatus for managing task bar buttons according to the invention.

### DETAILED DESCRIPTION

The technical solutions of the embodiments of the invention will be clearly and completely described in conjunction with the drawings in the embodiments of the invention. Obviously, the described embodiments are only part of the embodiments of the invention, but not all the embodiments. Based on the embodiments of the invention, all the other embodiments which can be obtained by the person skilled in the art without any creative labor fall into the scope protected by the invention.

A task bar is a typical graphical user interface on a computer, which includes user interface elements corresponding to application programs, windows, files or any other elements associated with data or data processing on the computer. The task bar is typically located on the edge of a display screen, such as the bottom edge, and may include several icons of computer utility programs. In addition, the task bar typically includes task bar buttons. The task bar buttons are elements embedded in the task bar, which provide a visual manner to determine which windows or application programs are currently active on the computer. Since the windows or the application programs may be minimized on the display screen due to various reasons, them are not always explicit.

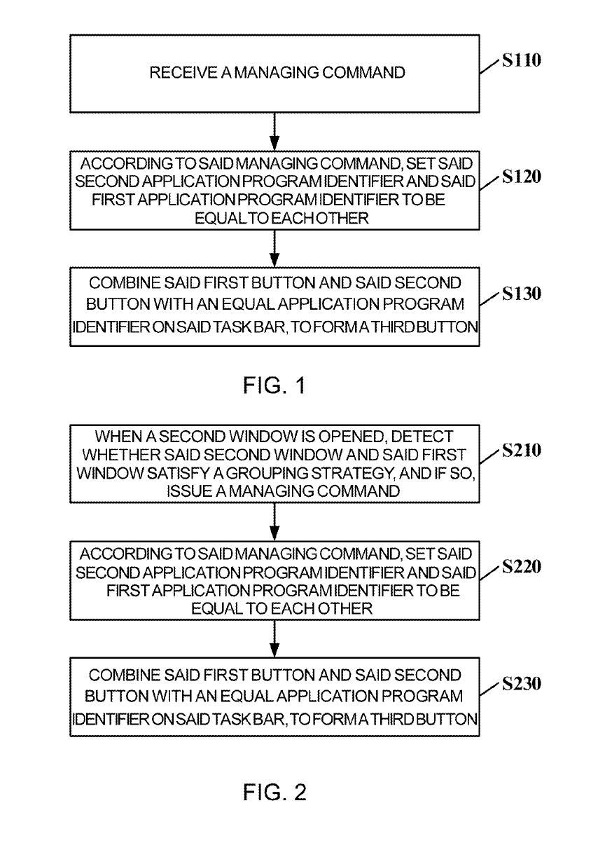

Referring to FIG. 1, a flowchart of a first embodiment of a method for managing task bar buttons according to the invention is shown. The method for managing the task bar buttons of the embodiment is applied to an operating system which may be Windows XP operating system, Linux operating system, Mac operating system or other operating systems. When a user operates the operating system, many windows will be opened. In order to facilitate the description, the windows are denoted by a first window and a second window, for easy understanding. The first window or the second window does not particularly specify a specific window, but may represent all the windows on the operating system desktop. Others such as a first button, a second button or a first application program identifier, or a second application program identifier does not specify a specific object, and does not indicate a particular order of these objects either.

The method of the embodiment is applied to a system having a first window and a second window, said first window corresponding to a first button of a task bar and having a first application program identifier, said second window corresponding to a second button of the task bar and having a second application program identifier, the method comprising:

Step S110, receiving a managing command;

Step S120, according to said managing command, setting said second application program identifier and said first application program identifier to be equal to each other.

For example, in a Windows operating system, said application program identifier is indicated by APPID (an Application User Model ID).

The implementations for setting said second application program identifier and said first application program identifier to be equal to each other include at least three types of: setting the value of said second application program identifier to be the value of said first application program identifier, while remaining the value of said first application program identifier unchanged; setting the value of said first application program identifier to be the value of said second application program identifier, while remaining the value of said second application program identifier unchanged; and setting said second application program identifier and said first application program identifier to be an equal third value. In the embodiment, said setting procedure is performed by the operating system.

The method further comprises: step S130, combining said first button and said second button with an equal application program identifier on said task bar, to form a third button.

In the Windows operating system, if the first application program identifier APPID of the first window and the second application program identifier APPID of the second window are equal to each other, the first button corresponding to the first window and the second button corresponding to the second window are grouped into a group, to form the third button. In the embodiment, the presentation manner of said third button is the combination of the first button and the second button, i.e., the combination of a plurality of buttons, but not a single button.

Since said third button is a button group including the first button and the second button, in the particular implementation procedure, the display content of said third button can be determined according to the attribute relationship or other relationships between the buttons. That is, a first display content of the first button is obtained; then, a second display content of the second button is obtained; the relationship between said first display content and said second display content is determined; if a predefined display strategy is satisfied, the third button displays the corresponding content according to the predefined display strategy; if the predefined display strategy is not satisfied, the third button displays the combination of the first display content and the second display content; of course, the display content of the third button can be determined by the user himself.

Said predefined display strategy may include: if said first display content and said second display content are the same or partially the same, a third display content of said third button may be the same part or the partially same part and the number of the buttons included in the third button group;

Alternatively, if the application program name of said first button and the application program name of said second button are the same or partially the same, the third display content of the third button may be the same part or the partially same part, the number of the buttons included in the third button group, and the number of the application program names: for example, the application program name for identifying the first button is Internet Explore, the application program name of the second button is also Internet Explore, and the combined third button may display “2 Internet Explore”, and may also display “2 IE”.

The combination of the first display content and the second display content may include: shrinking said first display content and said second display content, and displaying them side by side, as the third display content of the third button; alternatively, displaying the abstracts (such as abridgments or abbreviations) of the first display content and the second display content side by side, as the third display content; or extracting the icons of the first display content and the second display content, and displaying side by side as the third display content.

In another embodiment, the step S120 also can be implemented by an external program outside the operating system, in which case, the step S120 may include:

Step S121, obtaining a first window handle of said first window and a second window handle of said second window;

Step S122, obtaining a first process corresponding to said first window handle and a second process corresponding to said second window handle;

Step S123, according to said managing command, injecting a code segment or a Dynamic Link Library (DLL) which sets application program identifiers into said first process and said second process, obtaining the first application program identifier of said first window and the second application program identifier of said second window, and setting said second application program identifier and said first application program identifier to be equal to each other.

In another embodiment of the invention, the method may further include before said step S110:

Step S140, obtaining a moving operation on said first button or said second button of said task bar from a user.

The moving on said first button or said second button from the user can be implemented by a mouse, or by a touch screen or other manners. For example, the user moves said second button onto the position of the first button by the mouse, or moves said second button onto the position of the first button by the touch screen, or simultaneously or respectively moves the first button and the second button onto a third position. Said moving operation may be moving out an object (the first button or the second button) from the corresponding button group which is spread upwards from said third button; or moving a button into the corresponding button group which is spread upwards from said third button, that is, adding or deleting a number of buttons into or from said third button.

The method may further include before said step S110: step S150, when said moving operation makes said first button at least partially overlap with said second button, generating said managing command.

When said moving operation makes said first button at least partially overlap with said second button, that is, the user wants to group the first button and the second button into one group, said managing command is generated, and then the method proceeds to the step S110.

Determining whether said first button at least partially overlaps with said second button may depend on the coordinates of the boundaries of said first button and said second button. The coordinates of the diagonal endpoints of the first button are obtained, thereby obtaining the boundaries of the first button, as the starting boundaries of the first button; the coordinates of the diagonal endpoints of the second button are obtained, thereby obtaining the boundaries of the second button, as the starting boundaries of the second button; a moving command on said first button is received, said moving command determining the target boundaries of said first button; it is detected whether the target boundaries of said first button overlap with the starting boundaries of said second button, if so, said managing command is generated. Certainly, for the case that the first button and the second button are simultaneously or respectively moved onto a third position, the above manner may be similarly utilized. Other determining manners are also possible, and there is no limit on it.

A particular application scene of the embodiment of the invention is grouping the task bar buttons corresponding to the opened windows on the desktop.

The technical solution of the embodiment of the invention may modify the application program identifiers of the windows corresponding to the task bar buttons that is desired to be grouped into the same group to the same value by modifying the application program identifiers of the windows corresponding to the task bar buttons, so that the task bar buttons corresponding to the windows with the same application program identifier can be grouped into a group, so if the user wants to group two buttons into a group, he only needs to set the APPID of the windows corresponding to the two buttons to be equal to each other. According to the method of the embodiment, a plurality of buttons on the task bar may be arbitrarily combined into a task button group. The embodiment of the invention provides a new grouping manner for task bar buttons which can flexibly define the grouping of the task bar buttons according to the demand of a user, thereby satisfying personality demand of the user, improving the convenience of the user operation and bringing better user experience.

Referring to FIG. 2, FIG. 2 shows a flowchart of a second embodiment of a method for managing task bar buttons according to the invention. The method for managing the task bar buttons of the embodiment is applied to an operating system which may be Windows XP operating system, Linux operating system, Mac operating system or other operating systems.

The method of managing the embodiment is applied to a system having a first window, said first window corresponding to a first button of a task bar and having a first application program identifier. Said first window does not specify any specific window, but indicates an already opened window. The method comprising:

Step S210, when a second window is opened, detecting whether said second window and said first window satisfy a grouping strategy, and if so, issuing a managing command.

Said second window corresponds to a second button of a task bar and has second application program identifier. In the Windows operating system, said application program identifier is represented by an APPID (Application User Model ID).

Further, the method further includes a step for generating a grouping strategy before the step S210: according to application program names, application program attributes, or application process attributes, generating said grouping strategy.

Said grouping strategy can be generated by performing setting according to actual demands in advance, for example, the grouping strategy can be generated according to the application program names, that is, the grouping strategy includes the same or partially same application program name, said grouping strategy can be stored as a configuration file manner, when the second window is opened, if it is detected that the application program names of the second window and the first window are the same or partially the same, they are grouped into a group; alternatively, the grouping strategy can be generated according to the application program attributes, that is, said grouping strategy includes the application programs of the same attribute, the application programs can be divided into system application programs (such as application programs provided in the Windows system), external application programs and so on according to the attributes. After the grouping strategy is generated according to application program attributes, for example, when the second window is opened, it is detected whether the application programs corresponding to the second window and the first window both are the application programs provided in the Windows system, and if so, they are grouped into a group.

Generating the grouping strategy according to keywords is similar to generating the grouping strategy according to the application program names, which will not be described herein.

The grouping strategy is generated according to the application process attributes, and said application process attribute is the type of the application process, such as Word application process or IE application process or the like.

That is, said grouping strategy includes the application processes of the same attribute. For example, the grouping strategy is generated according to the Word document process. When the second windows is opened, if it is detected that the second window and the first window both are the Word processes, they are grouped into a group.

It can be understood that said grouping strategy is not limited to be generated only according to the application program names, the application program attributes or the application process attributes, and said grouping strategy can be implemented by the user himself, and there may be other various implementations for generating the grouping strategy; for example, all the files under the same folder are set to generate a grouping strategy, that is, the grouping strategy configuration file includes: detecting whether the files corresponding to the first button and the second button belong to the same folder; or all the files having the same author are set to generate a grouping strategy, that is, the grouping strategy configuration file includes: detecting whether the author parameters in the file attributes of the files corresponding to the first button and the second button are the same; or searching results are set to generate a grouping strategy, that is, each time the keyword is searched, all the files on the searching result list are added into a group of configurations of the grouping strategy configuration files, and it is detected whether the files corresponding to the opened first button and the opened second button belong to the group of configurations; in all, the setting manners of said grouping strategy can be various, and the user himself can further arbitrarily define it according to the actual demands, and the invention does not limit this.

Further, said grouping strategy may be the last grouping of the task bar buttons, that is, the grouping is saved after the task bar buttons are grouped, to generate the grouping strategy, and when the same window is opened again, the corresponding button enters into the same button group.

The method further comprises: step S220, according to said managing command, sets said second application program identifier and said first application program identifier to be equal to each other.

The implementations for setting the second application program identifier and the first application program identifier to be equal to each other have at least three types of: that is, setting the value of said second application program identifier to be the value of said first application program identifier, while remaining the value of said first application program identifier unchanged; setting the value of said first application program identifier to be the value of said second application program identifier, while remaining the value of said second application program identifier unchanged; and setting said second application program identifier and said first application program identifier to be an equal third value.

The method further comprises: step S230, combines said first button and said second button with an equal application program identifier on said task bar, to form a third button.

In the Windows operating system, if the first application program identifier APPID of the first window and the second application program identifier APPID of the second window are equal to each other, the first button corresponding to the first window and the second button corresponding to the second window will be combined into a group on said task bar, to form the third button. In the embodiment, the representation of the third button is the combination of the first button and the second button, i.e., the combination of a plurality of buttons, but not a single button,

Since said third button is a button group including the first button and the second button, during the particular implementation, the display content of said third button can be determined according to the grouping strategy, that is, in the grouping strategy, it is necessary to record the display content of the third button after the grouping with respect to each grouping strategy. For example, if it belongs to one folder, the name of the folder may be displayed; if it belongs to one search result, the keyword used in the searching may be displayed; and if it is the document with respect to the same author, the author name may be displayed and so on.

After said step S230, the method can further include a step of according to the grouping strategy generated after the grouping:

Obtaining first window information of said first window and second window information of said second window.

The window information includes: window title information, window pattern information, process information in the window and the APPID information of the window and so on.

Generating said grouping strategy according to said first window information and said second window information. That is, the first window information and the second window information are saved in a group of configurations of the grouping strategy file, defining that the window information of the group of configurations will be grouped into a group if it is opened in the future.

The above embodiment is the description that after the task bar buttons are grouped, the grouping information is saved to generate the grouping strategy, and when the same window is opened again, the corresponding button enters into the same button group.

In the embodiment, if the value of the second application program identifier is set as the value of the first application program identifier, the second button will be grouped into the button group that the first button corresponds to.

The particular application scene of the embodiment of the invention is that the task bar buttons corresponding to the windows being opened on the desktop are grouped, that is, after the window opened, the corresponding task bar buttons have been grouped and entered into the corresponding task bar button group.

The technical solution of the embodiment of the invention modifies the application program identifiers of the windows corresponding to the task bar buttons that is desired to be grouped into the same group to the same value by modifying the application program identifiers of the windows corresponding to the task bar buttons so that the task bar buttons corresponding to the windows with the same application program identifier can be grouped into a group, so if the user wants to group the two buttons into a group, he only needs to set the APPIDs of the windows corresponding to the two buttons to be equal to each other, and according to the method of the embodiment, a plurality of buttons on the task bar can be arbitrarily combined into a task bar group. The embodiment of the invention provides a new grouping manner for the task bar buttons, which can flexibly define the grouping of the task bar buttons according to the demand of a user, thereby satisfying personality demand of the user, improving the convenience of the user's operation and bringing better user experience.

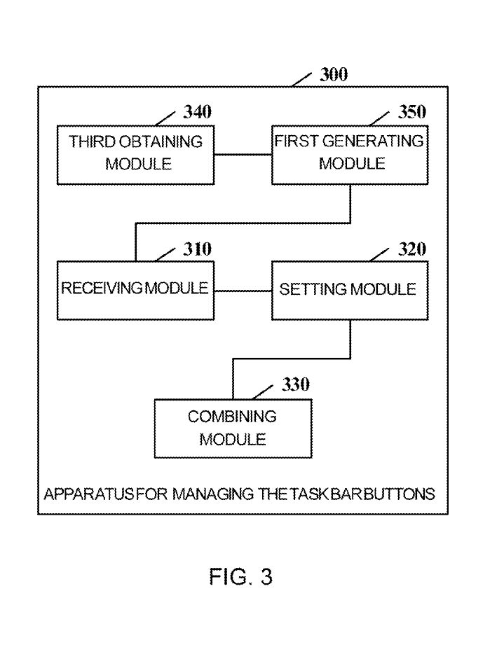

Referring to FIG. 3, FIG. 3 shows a structural view of a first embodiment of a apparatus for managing task bar buttons according to the invention. The apparatus 300 for managing the task bar buttons is applied to a system having a first window and a second window, said first window corresponding to a first button of a task bar and having a first application program identifier, said second window corresponding to a second button of the task bar and having a second application program identifier. The apparatus 300 for managing the task bar buttons comprises: a receiving module 310, a setting module 320 and a combining module 330.

Said receiving module 310 is for receiving a managing command;

Said setting module 320 is for, according to said managing command, setting said second application program identifier and said first application program identifier to be equal to each other.

The implementations for setting said second application program identifier and said first application program identifier to be equal to each other include at least three types of: setting the value of said second application program identifier to be the value of said first application program identifier, while remaining the value of said first application program identifier unchanged; setting the value of said first application program identifier to be the value of said second application program identifier, while remaining the value of said second application program identifier unchanged; and setting said second application program identifier and said first application program identifier to be an equal third value.

Said combining module 330 is for combining said first button and said second button with an equal application program identifier on said task bar, to form a third button.

In the embodiment, the presentation manner of said third button is the combination of the first button and the second button, i.e., the combination of a plurality of buttons, but not a single button.

In another embodiment, said apparatus 300 for managing the task bar buttons can further include:

Display content determining module (not shown in figures) is for determining the display content of the third button.

The display content of the third button can be determined according to the attribute relationship or other relationship between respective buttons.

That is, a first display content of the first button is obtained; then, a second display content of the second button is obtained; the relationship between said first display content and said second display content is determined; if a predefined display strategy is satisfied, the third button displays the corresponding content according to the predefined display strategy; if the predefined display strategy is not satisfied, the third button displays the combination of the first display content and the second display content; of course, the display content of the third button can be determined by the user himself.

Said predefined display strategy may include: if said first display content and said second display content are the same or partially the same, a third display content of said third button may be the same part or the partially same part and the number of the buttons included in the third button group;

Alternatively, if the application program name of said first button and the application program name of said second button are the same or partially the same, the third display content of the third button may be the same part or the partially same part, the number of the buttons included in the third button group, and the number of the application program names: for example, the application program name for identifying the first button is Internet Explore, the application program name of the second button is also Internet Explore, and the combined third button may display “2 Internet Explore”, and also may display “2 IE”.

The combination of the first display content and the second display content may include: shrinking said first display content and said second display content, and displaying them side by side, as the third display content of the third button; alternatively, displaying the abstracts (such as abridgments or abbreviations) of the first display content and the second display content side by side, as the third display content; or, extracting the icons of the first display content and the second display content side by side, as the third display content.

In another embodiment, said setting module 320 may include:

First obtaining submodule (not shown in figures) which is used to obtain a first window handle of said first window and a second window handle of said second window;

Second obtaining submodule (not shown in figures) which is used to obtain a first process corresponding to said first window handle and a second process corresponding to said second window handle;

Setting submodule (not shown in figures) which is used to according to said managing command, inject a code segment or a Dynamic Link Library (DLL) which sets application program identifiers into said first process and said second process, obtain the first application program identifier of said first window and the second application program identifier of said second window, and set said second application program identifier and said first application program identifier to be equal to each other.

In another embodiment of the invention, the apparatus 300 for managing the task bar buttons may include:

Third obtaining module 340 which is used to obtain a moving operation on said first button or said second button of said task bar from a user.

The moving on said first button or said second button from the user can be implemented by a mouse, or by a touch screen or other manners. For example, the user moves said second button onto the position of the first button by the mouse, or moves said second button onto the position of the first button by the touch screen, or moves the first button and the second button onto a third position . . . .

The apparatus 300 for managing the task bar buttons may further include: first generating module 350, which is used to generate said managing command when said moving operation makes said first button at least partially overlap with said second button.

The particular application scene of the embodiment of the invention is grouping the task bar buttons corresponding to the opened windows on the desktop.

The technical solution of the embodiment of the invention modifies the application program identifiers of the windows corresponding to the task bar buttons that is desired to be grouped into the same group to the same value by modifying the application program identifiers of the windows corresponding to the task bar buttons, so that the task bar buttons corresponding to the windows with the same application program identifier can be grouped into a group, so if the user wants to group the two buttons into a group, he only needs to set the APPIDs of the windows corresponding to the two buttons to be equal to each other, and for the plurality of buttons on the task bar, the method according to the embodiment can be arbitrarily combined into a task bar group. The embodiment of the invention provides a new grouping manner for the task bar buttons, which can flexibly define the grouping of the task bar buttons according to the demand of a user, thereby satisfying personality demand of the user, improving the convenience of the user's operation and bringing better user experience.

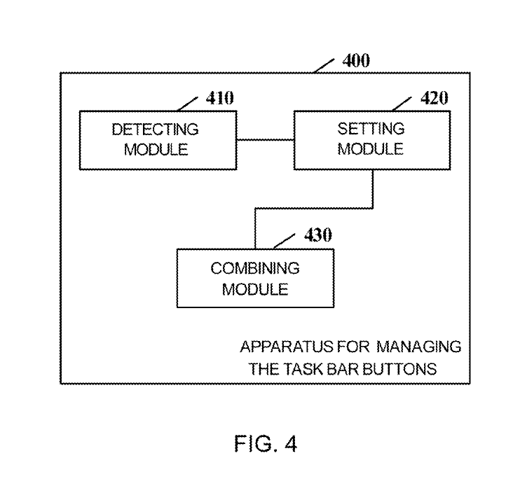

Referring to FIG. 4, FIG. 4 shows a structural view of a second embodiment of a apparatus for managing task bar buttons according to the invention. The apparatus 400 for managing the task bar buttons of the embodiment is applied to an operating system which may be Windows XP operating system, Linux operating system, Mac operating system or other operating systems. The apparatus of the embodiment is applied to a system having a first window, said first window corresponding to a first button of the task bar, and having a first application program identifier, wherein said first window does not specify any specific window, but indicates an already opened window.

Said apparatus 400 for said task bar buttons includes a detecting module 410, a setting module 420, and a combining module 430.

Said detecting module 410 is for, when a second window is opened, detecting whether said second window and said first window satisfy a grouping strategy, and if so, issuing a managing command.

Said second window corresponds to a second button of a task bar and has a second application program identifier.

Said second window corresponds to a second button of a task bar and has a second application program identifier. In the Windows operating system, said application program identifier is represented by an APPID (Application User Model ID).

In another embodiment, said apparatus 400 for managing said task bar buttons may further include a grouping strategy generating module (not shown in figures) for generating said grouping strategy according to application program names, application program attributes or application process attributes.

Said grouping strategy can be generated by setting according to actual demands in advance, such as according to application program names, application program attributes, keyword or application process attributes and so on. It can be understood that it is not limited to that said grouping strategy is generated only according to the application program names, the application program attributes or the application process attributes, and said grouping strategy can be implemented by other various implementations, for example, all the files under the same folder are set to generate a grouping strategy; or, all the files having the same author are set to generate a grouping strategy; or, searching results are set to generate a grouping strategy; or the processes with the same attribute are set to generate a grouping strategy and so on; in all, the setting manners of said grouping strategy can be various, and the user himself can further arbitrarily define it according to the actual demands, and the invention does not limit this.

Said setting module 420 is used to set said second application program identifier and said first application program identifier to be equal to each other according to said managing command.

The implementations for setting said second application program identifier and said first application program identifier to be equal to each other include at least three types of: setting the value of said second application program identifier to be the value of said first application program identifier, while remaining the value of said first application program identifier unchanged; setting the value of said first application program identifier to be the value of said second application program identifier, while remaining the value of said second application program identifier unchanged; and setting said second application program identifier and said first application program identifier to be an equal third value.

Said combing module 430 is for combining said first button and said second button with an equal application program identifier on said task bar, to form a third button.

In the embodiment, the presentation manner of said third button is the combination of the first button and the second button, i.e., the combination of a plurality of buttons, but not a single button.

In the embodiment, if the value of the second application program identifier is set as the value of the first application program identifier, the second button will be grouped into the button group corresponding to the first button.

Further, the apparatus 400 for managing said task bar buttons further includes:

A fourth obtaining module (not shown in figures) which is used to obtain first window information of said first window and second window information of said second window.

The window information includes: window title information, window pattern information, process information in the window and the APPID information of the window and so on.

The apparatus 400 for managing said task bar buttons further includes: second generating module (not shown in figures) which is used to generate said grouping strategy according to said first window information and said second window information.

A particular application scene of the embodiment of the invention is that the task bar buttons corresponding to the windows being opened on the desktop are grouped, that is, after the window opened, the corresponding task bar buttons have been grouped and entered into the corresponding task bar button group.

The technical solution of the embodiment of the invention modifies the application program identifiers of the windows corresponding to the task bar buttons that is desired to be grouped into the same group to the same value by modifying the application program identifiers of the windows corresponding to the task bar buttons, so that the task bar buttons corresponding to the windows with the same application program identifier can be grouped into a group, so if the user wants to group two buttons into a group, he only needs to set the APPID of the windows corresponding to the two buttons to be equal to each other. According to the method of the embodiment, a plurality of buttons on the task bar may be arbitrarily combined into a task button group. The embodiment of the invention provides a new grouping manner for task bar buttons which can flexibly define the grouping of the task bar buttons according to the demand of a user, thereby satisfying personality demand of the user, improving the convenience of the user operation and bringing better user experience.

The apparatus embodiment of the invention corresponds to the method embodiment, so the undescribed portion of the apparatus embodiment can be referred to the description of the related portion of the method embodiment.

The apparatus and the method of the invention may be not only applied to computer, but also applied to mobile phone, personal digital assistant, game machine or other devices which can define the grouping of the task bar buttons.

The person skilled in the art can understand that implementations of all or partial steps in the above method embodiment may be implemented by a program instructing related hardwares, and said program may be stored in a computer readable storage medium, and the program includes steps of the above method embodiment when being executed. Said storage medium is for example, magnetic disk, compact disk, Read-Only Memory (ROM), or Random Access Memory (RAM) and so on. In various method embodiments of the invention, the numbers of said various steps can not be used to limit the chronological order of the various steps. For the person skilled in the art, without any creative labor, the change of the chronological order of the various steps is within the protection scope of the invention.

The above description is only the preferred embodiments of the invention, but not used to limit the invention, and any modification, equal alternation, improvement and so on made should be included in the protection scope of the invention.

1. A method for managing task bar buttons, applicable to a system having a first window and a second window, wherein said first window corresponding to a first button of a task bar and having a first application program identifier, said second window corresponding to a second button of the task bar and having a second application program identifier, the method comprising:
receiving a managing command;
according to said managing command, setting said second application program identifier and said first application program identifier to be equal to each other; and
combining said first button and said second button with an equal application program identifier on said task bar, to form a third button.

2. The method for managing task bar buttons according to claim 1, wherein, said according to said managing command, setting said second application program identifier and said first application program identifier to be equal comprises:
obtaining a first window handle of said first window and a second window handle of said second window;
obtaining a first process corresponding to said first window handle and a second process corresponding to said second window handle; and
according to said managing command, injecting a code segment or a Dynamic Link Library (DLL) which sets application program identifiers into said first process and said second process, obtaining the first application program identifier of said first window and the second application program identifier of said second window, and setting said second application program identifier and said first application program identifier to be equal.

3. The method for managing task bar buttons according to claim 1, wherein, said setting said second application program identifier and said first application program identifier to be equal comprises:
setting said second application program identifier and said first application program identifier to be an equal third value.

4. The method for managing task bar buttons according to claim 1, wherein, before said receiving a managing command, the method further comprises:
obtaining a moving operation on said first button or said second button of said task bar from a user; and
when said moving operation makes said first button at least partially overlap with said second button, generating said managing command.

5. A method for managing task bar buttons, applicable to a system having a first window, said first window corresponding to a first button of a task bar and having a first application program identifier, the method comprising:
when a second window is opened, detecting whether said second window and said first window satisfy a grouping strategy, and if so, issuing a managing command, wherein, said second window corresponding to a second button of a task bar and having a second application program identifier;
according to said managing command, setting said second application program identifier and said first application program identifier to be equal; and
combining said first button and said second button with an equal application program identifier on said task bar, to form a third button.

6. The method for managing task bar buttons according to claim 5, wherein, before said detecting whether said second window and said first window satisfy a grouping strategy, the method further comprises:
according to application program name, application program attribute, or application process attribute, generating said grouping strategy.

7. The method for managing task bar buttons according to claim 5, wherein, after said combining said first button and said second button with an equal application program identifier on said task bar, to form a third button, the method further comprises:
obtaining first window information of said first window and second window information of said second window; and
generating said grouping strategy according to said first window information and said second window information.

8. A apparatus for managing task bar buttons, applicable to a system having a first window and a second window, said first window corresponding to a first button of a task bar and having a first application program identifier, said second window corresponding to a second button of the task bar and having a second application program identifier, the apparatus comprising:
receiving module, configured for receiving a managing command;
setting module, configured for, according to said managing command, setting said second application program identifier and said first application program identifier to be equal to each other; and
combining module, configured for combining said first button and said second button with an equal application program identifier on said task bar, to form a third button.

9. The apparatus for managing task bar buttons according to claim 8, wherein, said setting module includes:
first obtaining submodule, configured for obtaining a first window handle of said first window and a second window handle of said second window;
second obtaining submodule, configured for obtaining a first process corresponding to said first window handle and a second process corresponding to said second window handle; and
setting submodule, configured for, according to said managing command, injecting a code segment or a Dynamic Link Library (DLL) which sets application program identifiers into said first process and said second process, obtaining the first application program identifier of said first window and the second application program identifier of said second window, and setting said second application program identifier and said first application program identifier to be equal to each other.

10. The apparatus for managing task bar buttons according to claim 8, further comprising:
third obtaining module, configured for obtaining a moving operation on said first button or said second button of said task bar from a user; and
first generating module, for, when said moving operation makes said first button at least partially overlap with said second button, generating said managing command.

11. A apparatus for managing task bar buttons, applicable to a system having a first window, said first window corresponding to a first button of a task bar and having a first application program identifier, the method comprising:
detecting module, configured for, when a second window is opened, detecting whether said second window and said first window satisfy a grouping strategy, and if so, issuing a managing command, said second window corresponding to a second button of a task bar and having a second application program identifier;
setting module, configured for, according to said managing command, setting said second application program identifier and said first application program identifier to be equal to each other; and
combining module, for combining said first button and said second button with an equal application program identifier on said task bar, to form a third button.

12. The apparatus for managing task bar buttons according to claim 11, wherein, the apparatus further includes:
fourth obtaining module, configured for obtaining first window information of said first window and second window information of said second window; and
second generating module, configured for generating said grouping strategy according to said first window information and said second window information.
